(19) United States
(12) Patent Application Publication
(10) Pub. No.: US 2015/0020051 A1
(43) Pub. Date: Jan. 15, 2015

(54) METHOD AND APPARATUS FOR AUTOMATED CONVERSION OF SOFTWARE APPLICATIONS

(71) Applicants: Yuri G. Rabinovitch, Riverwoods, IL (US); Vit Kantor, Wauconda, IL (US)

(72) Inventors: Yuri G. Rabinovitch, Riverwoods, IL (US); Vit Kantor, Wauconda, IL (US)

(21) Appl. No.: 13/939,149

(22) Filed: Jul. 10, 2013

(51) Int. Cl. G06F 9/45; G06F 11/36

(52) U.S. Cl. CPC G06F 8/51; G06F 11/3684; G06F 11/3692
USPC 717/124; 717/136

(57) ABSTRACT

The invention relates to data processing apparatus and methods for automated conversion of software applications between computing platforms when said platforms do not support common set of programming languages. The Conversion System (CS) consists of several components. The Converter is a computer system that translates source application's code into target application's code. It uses set of methods to create in the target system's programming language constructs that represent source system language's constructs and that the Run Time Library (RTL) implements and supports at run time. The RTL also provides for supporting multiple target computing platforms as it insulates converted code from each target platform's specifics. The CS converts legacy applications' source code in the manner that preserves applications' structure, “look and feel”, interfaces between components, and processing flows, and thus allows to reuse test data and testing approaches that have been used with the legacy applications before conversion.

### CROSS-REFERENCE TO RELATED APPLICATIONS

This application claims the benefit of U.S. Provisional Application Ser. No. 61/670,346, filed Jul. 11, 2012, which is hereby incorporated by reference in its entirety.

### FIELD OF THE INVENTION

The invention relates to data processing apparatus and methods for automated conversion of software applications between computing platforms when said platforms do not support common set of programming languages. The conversion preserves intellectual property invested into a source application, and creates on a target platform a converted application that: a) produces the same results as the source system, and b) has structure and internal behavior that are very close to the structure and internal behavior of the source system.

### BACKGROUND OF THE INVENTION

There is a well-recognized need to have the means for conversion of software applications between different platforms, in particular in situations when a programming language utilized on a source platform is not available on a target platform. This task is especially relevant for moving software applications from outdated, proprietary legacy environments into modern, open, less expensive environments.

Two alternatives to computer software applications conversion are re-hosting and re-writing the system. Re-writing is expensive and time-consuming and does little to preserve intellectual property and team expertise.

Re-hosting just replaces a hardware/operating system platform that an application uses to new ones. In many cases re-hosting is not even possible, because implementation of the source platform's programming environment does not exist on the target platform. In particular, this is the case with UNISYS MCP ALGOL and COBOL programming environments.

In the opposite to re-hosting, conversion does not just allow to move to a different hardware platform, but also to a different, open programming environment thus greatly increasing capabilities for system expansion and simplifying maintenance. Unfortunately, in situations when important programming constructs widely used on a source (legacy) computing platform do not have direct, or even close analogues on target computing platform(s), the known automated conversion means produce converted code that looks very dissimilar to the source system code, has different internal structure and internal behavior(flows of execution). And this causes the loss of large amounts of intellectual property invested into the application, and significantly complicates system's testing and maintenance. Such a conversion also causes loss of expertise of the personnel that maintains and operates an application on its source platform.

There is a clear need to have a conversion means that, on one hand, facilitates maintainability and testing of converted code while preserving structure, “look and feel”, and processing sequences of the source system code, and, on the other hand, produces an open, expandable converted system code that is capable to use modern interfaces to communicate with other components.

### BRIEF SUMMARY OF THE INVENTION

The invention relates to a novel Conversion System (CS) that is capable to convert software applications between platforms that have no common set of programming languages. The CS is comprised of two general components: Converter and Run Time Library (RTL). The RTL implements programming constructs that are widely used in the source system's code (that is in the code that needs to be converted) and do not have analogues in the target system's computing environment. The Converter is a computer system that translates source application's code into target application's code. It uses set of methods to create in the target system's programming language constructs that represent source system language's constructs and that The RTL implements and supports at run time. The RTL also provides for supporting multiple target computing platforms as it insulates converted code from each target platform's specifics.

A further aspect of the invention refers to a method and apparatus for conversion from one language to another using large number of conversion passes (through the source system's code) utilizing variable grammars. On each pass only limited elements of the code under conversion are recognized based on the context available. Each construct that has been recognized contributes to the context and helps, on some future pass, to recognize additional elements of the source code, and, in turn, enrich the parsing context.

The invention further relates to a novel method of modernizing legacy applications by using The CS to convert legacy applications' source code in the manner that preserves applications' structure, “look and feel”, interfaces between components, and processing flows, and thus allows to reuse test data and testing approaches that have been used with the legacy applications before conversion.

In another aspect of the invention, the CS implements a number of novel and specific ways to represent programming constructs unique for UNISYS MCP ALGOL and COBOL environments on computing platforms that do not support these constructs.

### DETAILED DESCRIPTION OF THE INVENTION

In the preferred embodiment Converter is a computer system that translates source application's code into target application's code. It uses a set of methods (described below) to create in the target system's programming language constructs that represent source system language's constructs. In some cases there is a simple mapping between constructs supported by the source and the target programming languages. In the cases when such simple mapping does not exist the Converter maps source language's constructs into constructs that are implemented by the 2nd component of the invention—the Run Time Library (RTL).

In another embodiment the Converter may also generate documentation that describes detailed structure and components of the source system. This function may be used to document an existing source system, without conversion to a target platform.

The Converter utilizes mechanisms described below to preserve in converted code layout, names, and comments from the source code. As the result, even though converted application is in a different language than the original one, it still looks familiar to the personnel that have been working with the original application. Because the application's layout is preserved, the converted application may be tested in the same points and using the same test data and harnesses as the original system.

The RTL implements (for a particular target platform) constructs that the Converter generates. Thus, the RTL isolates developers and the Converter component from target platforms' specifics, allows once—converted application to execute on multiple target platforms, and allows for platform—specific performance tuning, if necessary.

In the preferred embodiment the RTL is structured as 2 libraries. One library is platform—independent, and implements constructs that represent source language's constructs in the target language; another library implements target platform—specific system functions, such as logging, tracing, threads management, etc. Such solution isolates system—specific functionality and provides for high degree of portability, performance, and ease of maintenance. In another embodiment the RTL may be structured not as 2, but as one library that contains both source language's constructs implementation, and target platform—specific system functions. In yet another embodiment RTL may be absent as a separate structural component. Instead of Converter generating constructs implemented by RTL and using RTL at run time to support such constructs, Converter may generate code for target platform that directly includes implementation of the constructs into which source language's constructs are mapped.

Converter and RTL may be used on the same or different platforms. In the latter case converted code must be moved for execution to the target platform that is equipped with a suitable version of the RTL.

Converter may be structured as a standalone command—line tool, or it may be integrated with an Integrated Development Environment (IDE, such as Microsoft Visual Studio, Eclipse, or custom IDE.). Such an integration may ease navigating in parallel through source code and conversion results (converted code, conversion log data, etc.), keeping track of conversion process (parts converted, parts that have to be converted, etc.), and keeping track of manual changes introduced into source and/or converted code.

In another aspect of the invention, Converter comprises a method and apparatus for conversion from one language to another using large number of conversion passes with variable grammar. Having large number of passes, and specialized, simple grammars on each pass, allows for using different, narrowly targeted, and thus significantly simplified algorithms for lexical, syntax, and semantic analyzers on each pass. The method reduces a complicated conversion process to a large number of simple steps; conversion decisions are postponed until the necessary information is accumulated, and the entire conversion process may be easily modified because there are no complex grammars and dependencies that have to be considered all at once.

This multi-pass, variable-grammar translation mechanism is also applicable not just to software systems, but to texts expressed other formal or natural languages.

In yet another aspect of the invention, the CS comprises an apparatus and methods of conversion that facilitates ease of maintenance and testing for converted system by preserving the source system's structure, comments, and variables and function names. Converter also automatically includes special comments into converted code that explain specifics of the converted constructs, provide warnings to developers, if required, and facilitate manual review and maintenance of converted code. Converter also facilitates ease of maintenance and testing for converted system by automatically instrumenting converted code for logging/tracing/performance data collection. RTL provides support for such logging and tracing functionality. In one embodiment Converter automatically inserts tracing statements at the entry and exit points of individual functions in converted code.

In yet another aspect of the invention, the CS comprises an apparatus and methods for testing converted systems. As the CS preserves the original system's structure, processing flows, and inter-component interfaces, the converted code may be tested at the same critical points/interfaces, and using the same test data and test scenarios as the original system. A complimentary testing approach that the CS allows is to test converted and original system components together/in parallel. Due to the fact that converted system uses the same interfaces and processing flows as the original one, components of the original and converted system may be made to interface with one another, and the fact that some components are original and the others are converted ones is transparent from the testing perspective. This allows for incremental testing of converted code in the entire system's context, by introducing converted components into the test mix as they become available.

A further aspect of the invention relates to a method and apparatus for controlling conversion process by using special comments in a source system as directives to the Converter. When Converter encounters such a special directive (represented as a comment in the source code of the system that is being converted), it performs the required function as specified. Such a directive may, for example, dictate which constructs of the target language to use to represent a particular fragment of the source system.

In one embodiment this mechanism may be used to direct EBCDIC to ASCII conversion by utilizing directives to set source and target encoding in converted text

Another aspect of the invention relates to a method of conversion that allows for preserving comments and literals during conversion. This is achieved by removing comments and literals temporarily from the source text during conversion, storing them in specialized registries, and re-inserting them back later for processing at a specific conversion pass.

Yet another aspect of the invention relates to a method of conversion that allows for splitting large source files into smaller pieces. Converter generates header files with function prototypes, macro definitions and declaration of external variables from the original file. This generated header file then may be included into other files with converted code.

Yet another aspect of the invention relates to a method of conversion for local functions used in a source programming language into global functions in a target programming language. Converter performs static analysis of context dependencies, and adds this information as parameters to converted functions.

Another aspect of the invention relates to a method of conversion of a source system's programming language's simple types that preserves their in-memory representation and memory footprint (size), and allows the same granularity of access to the basic types' components (words, bits) in converted code as in source code. This is achieved by implementing a flat object model for modeling source language's types in the target language that does not require storing any additional information in the target system's objects.

Yet another aspect of the invention relates to a method of conversion for string literals that contain zero characters by using special container objects.

A further aspect of the invention relates to a method of conversion for global GOTO statements (if target language does not support global GOTO) by adding special GOTO -related parameters in corresponding functions (functions where global GOTO is invoked) and generating wrappers around these function calls.

In one embodiment, when source software application is implemented in UNISYS MCP ALGOL (or its dialects and variants such as NEWP, DMALGOL, DCALGOL), and target software application is in C++, or another object-oriented language (such as C#, or Java, or similar languages) on UNIX, Linux, or Windows, the CS comprises, in addition, the following specific methods of conversion:
Method of conversion for partial word (bit) operations in ALGOL into the target language's operations by using special objects that semantically represent a reference to a specific part of another object, thus allowing for use of partial words on both the left hand side and the right hand side of assignment operators.
Method of conversion for complex REPLACE and SCAN operations by using manipulator functions that prepare/accumulate parameters for a future read/write action, with the action itself postponed till the end of the statement's execution.
Method of conversion for ALGOL references and some procedure parameters that are not defined as VALUE by using special reference objects instead of the target language's references.
Method of conversion for ALGOL memory protection functionality by using special object data members instead of the target language's const qualifier.
Method of conversion for ALGOL macro definitions that represent only a part of an ALGOL statement and whose precise meaning may depend on the program's context and can be determined only at some later stage. This is achieved by using special objects that represent pairs or triplets of values, and who's meaning changes depending on the program context in which they are used.
Method of conversion for CASE values selection operator in ALGOL by utilizing multiple ternary ?: operators in the target language's (where such operation is available)
Method of conversion for ALGOL structures with arrays by using default array constructor and special array initialization function in generated structure constructor in the target language.
Method of conversion for PROLOG and EPILOG functions in ALGOL structures by representing them as parts of constructor and destructor for the structure in the target language.
Method of conversion for literal strings in ALGOL to enable their use as const expressions in the target language (i.e. for case labels). It involves disassembling of a string onto separate characters, and using a special macro to create const value from these characters.
Method of conversion for BOOLEAN variables in ALGOL that utilizes cast to bool operator in the target language to enable unrestricted use of converted BOOLEAN variables in logical expressions in the target language
Method of conversion for ALGOL TASK construct that represents it as a specially managed thread in the target language to enable data sharing between tasks and tasks' control.
Method of conversion for ALGOL MYSELF statements that represents application's main loop as a separate task with pre-defined control block.
Method of conversion for DMSII interface from DMALGOL that represents DMSII statements as function invocations with names of DB tables and their columns as string literals.
Method of conversion for list-driven form of FOR loop that uses array of values from the list and iterator through that array.
Method of conversion for FORMAL PROCEDURE parameters that uses generation of type definition for the procedure parameter.
Method of conversion for IF statement which may be used in ALGOL as value utilizing formal analysis whether statement may be used as value or not and using ternary ?: operator if needed.
Method of conversion for A IMP B constructs by generating (!A∥B) code.
Method of conversion for ALGOL INTERRUPT statement by representing this statement as a function.
Method of conversion for LIBRARY and LINKLIBRARY statements using generated library initialization call.
Method of conversion for ALGOL compiler pre-processing $SET and $POP directives into #if, #endif and #define compiler pre-processing directives in target language (if the target language supports such constructs).

One skilled in the art will understand that the practice of the invention is not limited to the illustrative examples presented above. Further, one skilled in the art will understand that embodiments practicing aspects of the invention may achieve one or more of the many advantages of the invention noted in this application.

What is claimed as new is:

1. A data processing system having at least one processor for use in converting software applications between disparate computing platforms comprising: the Converter, which is a computer system that translates source application's code into target application's code, and the RTL, which is software that implements and provides supports at run time on target platform(s) for some programming constructs of the source system, in particular those that do not have analogues on target platform(s).

2. The system of claim 1 wherein the RTL is implemented in the following ways:
As multiple libraries, where some libraries are platform—independent, and implement constructs that represent source language's constructs in the target language; and other libraries implement target platform—specific system functions, such as logging, tracing, threads management, etc.
As one library that contains both source language's constructs implementation, and target platform—specific system functions.
As RTL code included (by the Converter, or through a separate process) into converted code for target platform(s).

3. The system of claim 1 wherein Converter and RTL may be used on the same or different platforms, and wherein the Converter may be structured as a standalone command—line tool, or it may be integrated with an Integrated Development Environment.

4. The system of claim 1 wherein the Converter and RTL together work in the manner that preserves in a converted system (code) most of the structure, comments, variables and function names, inter-component interfaces and processing flows of the original (source) code.

5. The system of claim 1 wherein converted code is automatically instrumented with code for logging/tracing/performance data collection, and the RTL or another facility provides support for such logging and tracing functionality.

6. A method for incremental testing of the converted (target system) comprising: (a) identifying interfaces/components in the source (original) system where testing was done, and identifying test data and procedures used to test the original system; (b) identifying the converted equivalents for interfaces/components described in step (a) above; (c) performing tests on the converted system's components/interfaces using the test data (and procedures) that have been used with the original system and comparing the results with the results received while testing the original system).

7. The method of claim 6, wherein the original and the converted systems are run “in parallel” with the same input data, the intermediate (output of specific components) and final results are compared, and the components that produce the results that differ between the original and the converted systems are identified.

8. The method of claim 6, wherein the converted components may be tested as they become ready, without waiting for the entire converted system to be available, comprising: (a) a converted component(s) is interfaced with appropriate components of the original system (inserted into the process flow); (b) the converted component(s) under the test receives the input and provides the output to the components it interfaces with; (c) the output of the converted component(s) under the test is compared with the output of the original component(s) that the original component has produced with the same input data as the one provided to the converted component(s) under the test.

9. A method for analyzing the source system's code and converting it into target system(s) code comprising using large number of conversion passes with variable grammar, wherein on each pass only limited elements of the code under conversion are recognized based on the context available, and each construct that has been recognized contributes to the context and helps, on some future pass, to recognize additional elements of the source code, and, in turn, enrich the parsing context.

10. The method of claim 9 wherein the control of the conversion process is done by using special comments in a source system as directives to the Converter, so when Converter encounters such a special directive (represented as a comment in the source code of the system that is being converted), it performs the required function as specified.

11. The method of claim 9 wherein preserving comments and literals during conversion is achieved by removing comments and literals temporarily from the source text during conversion, storing them in specialized registries, and re-inserting them back later for processing at a specific conversion pass.

12. The method of claim 9 wherein for splitting large source files into smaller pieces Converter generates header files with function prototypes, macro definitions and declaration of external variables from the original file, and this generated header file then may be included into other files with converted code.

13. The method of claim 9 wherein to convert local functions used in a source programming language into global functions in a target programming language, Converter performs static analysis of context dependencies, and adds this information as parameters to converted functions.

14. The method of claim 9 wherein a source system's programming language's simple types' in-memory representation and memory footprint (size) is preserved by implementing a flat object model for modeling source language's types in the target language that does not require storing any additional information in the target system's objects.

15. The method of claim 9 wherein string literals that contain zero characters are converted by using special container objects.

16. The method of claim 9 wherein global GOTO statements in situations when target language does not support global GOTO are converted by adding special GOTO-related parameters in the corresponding functions (functions where global GOTO is invoked) and by generating wrappers around these function calls.

17. A method of conversion when source software application is implemented in UNISYS MCP ALGOL (or its dialects and variants such as NEWP, DMALGOL, DCALGOL), and target software application is in C++, or another object-oriented language (such as C#, or Java, or similar languages) on UNIX, Linux, or Windows, comprising: (a) identification—by the Converter—of specific constructs that target platforms do not support (b) conversion of these constructs while preserving program's look and feel and structure; (b) implementation—by the RTL—of the converted constructs in the manner that implements the required functionality and preserves program structure and data layout.

18. The method of claim 17 wherein partial word (bit) operations in ALGOL are converted into the target language's operations by using special objects that semantically represent a reference to a specific part of another object, thus allowing for use of partial words on both the left hand side and the right hand side of assignment operators.

19. The method of claim 17 wherein conversion for complex REPLACE and SCAN operations is performed by using manipulator functions that prepare/accumulate parameters for a future read/write action, with the action itself postponed till the end of the statement's execution.

20. The method of claim 17 wherein conversion for ALGOL references and some procedure parameters that are not defined as VALUE is performed by using special reference objects instead of the target language's references.

21. The method of claim 17 wherein conversion for ALGOL memory protection functionality is performed by using special object data members instead of the target language's const qualifier.

22. The method of claim 17 wherein conversion for ALGOL macro definitions that represent only a part of an ALGOL statement and whose precise meaning may depend on the program's context and can be determined only at some later stage is achieved by using special objects that represent pairs or triplets of values, and who's meaning changes depending on the program context in which they are used.

23. The method of claim 17 wherein conversion for CASE values selection operator in ALGOL is performed by utilizing multiple ternary ?: operators in the target language's (where such operation is available)

24. The method of claim 17 wherein conversion for ALGOL structures with arrays by using default array constructor and special array initialization function in generated structure constructor in the target language.

25. The method of claim 17 wherein conversion for PROLOG and EPILOG functions in ALGOL structures is performed by representing them as parts of constructor and destructor for the structure in the target language.

26. The method of claim 17 wherein conversion for literal strings in ALGOL is performed to enable their use as const expressions in the target language (i.e. for case labels) by disassembling of a string onto separate characters, and using a special macro to create const value from these characters.

27. The method of claim 17 wherein conversion for BOOLEAN variables in ALGOL utilizes cast to bool operator in the target language to enable unrestricted use of converted BOOLEAN variables in logical expressions in the target language

28. The method of claim 17 wherein conversion for ALGOL TASK construct represents it as a specially managed thread in the target language to enable data sharing between tasks and tasks' control.

29. The method of claim 17 wherein conversion for ALGOL MYSELF statements represents application's main loop as a separate task with pre-defined control block.

30. The method of claim 17 wherein conversion for DMSII interface from DMALGOL represents DMSII statements as function invocations with names of DB tables and their columns as string literals.

31. The method of claim 17 wherein conversion for list-driven form of FOR loop uses array of values from the list and iterator through that array.

32. The method of claim 17 wherein conversion for FORMAL PROCEDURE parameters uses generation of type definition for the procedure parameter.

33. The method of claim 17 wherein conversion for IF statement which may be used in ALGOL as value is performed by utilizing analysis whether statement may be used as value or not and using ternary ?: operator if needed.

34. The method of claim 17 wherein conversion for A IMP B constructs is performed by generating (!A∥B) code.

35. The method of claim 17 wherein conversion for ALGOL INTERRUPT statement is performed by representing this statement as a function.

36. The method of claim 17 wherein conversion for LIBRARY and LINKLIBRARY statements is performed by using generated library initialization call.

37. The method of claim 17 wherein conversion for ALGOL compiler pre-processing $SET and $POP directives is performed into #if, #endif and #define compiler pre-processing directives in target language (if the target language supports such constructs).
